(19) United States
(12) Patent Application Publication
(10) Pub. No.: US 2002/0165952 A1
(43) Pub. Date: Nov. 7, 2002

(54) Systems and methods for remote management of diagnostic devices and data associated therewith

(76) Inventors: James M. Sewell, Dunwoody, GA (US); T. Thornton Muir, Atlanta, GA (US); Guy Lever, Atlanta, GA (US)

Correspondence Address: MCKENNA LONG & ALDRIDGE LLP, 1900 K STREET, NW, WASHINGTON, DC, 20006, US

(21) Appl. No.: 09/681,604

(22) Filed: May 7, 2001

Related U.S. Application Data
(60) Provisional application No. 60/241,898, filed on Oct. 20, 2000.

(51) Int. Cl. G06F 15/173; G06F 15/16

(52) U.S. Cl. 709/224; 709/202

(57) ABSTRACT

The present invention automates the tracking and monitoring of the repair process via automated malfunction analysis, diagnostic interface standardization, centralized maintenance and distribution of test scripts used by diagnostic devices and aggregation of analysis test data. A typical system includes a system processor and a system data store. The system processor receives diagnostic data from one or more diagnostic devices and stores the received diagnostic data set in the system data store. The system processor further generates and outputs reports analyzing a subset of the diagnostic data stored in the system data store.

### CROSS REFERENCE TO RELATED APPLICATIONS

This application claims the benefit, pursuant to 35 U.S.C. § 119(e), of applicant's provisional U.S. patent application Ser. No. 60/241,898, filed Oct. 20, 2000, entitled “Service Chain Management Automation Systems and Methods,” the disclosure of which is hereby incorporated by this reference for all purposes.

### BACKGROUND OF INVENTION

1. Field of Invention

The present invention relates to systems and methods for automating the tracking and monitoring of a malfunctioning item in a repair cycle. More particularly, the invention relates to systems and methods for automating the tracking and monitoring of the repair process via automated malfunction analysis, diagnostic interface standardization, centralized maintenance and distribution of test scripts used by diagnostic devices and aggregation of analysis test data.

2. Description of Related Art

The Internet is a global network of connected computer networks. Over the last several years, the Internet has grown in significant measure. A large number of computers on the Internet provide information in various forms. Anyone with a computer connected to the Internet can potentially tap into this vast pool of information.

The most wide spread method of providing information over the Internet is via the World Wide Web (the Web). The Web consists of a subset of the computers connected to the Internet; the computers in this subset run Hypertext Transfer Protocol (HTTP) servers (Web servers). The information available via the Internet also encompasses information available via other types of information servers such as GOPHER, SMTP (simple mail transfer protocol), POP3 (Post Office Protocol) and FTP (file transfer protocol).

Information on the Internet can be accessed through the use of a Uniform Resource Locator (URL). A URL uniquely specifies the location of a particular piece of information on the Internet. A URL will typically be composed of several components.

The first component typically designates the protocol by with the address piece of information is accessed (e.g., HTTP, GOPHER, etc.). This first component is separated from the remainder of the URL by a colon (‘:’). The remainder of the URL will depend upon the protocol component. Typically, the remainder designates a computer on the Internet by name, or by IP number, as well as a more specific designation of the location of the resource on the designated computer. For instance, a typical URL for an HTTP resource might be:

http://www.server.com/dir1/dir2/resource.htm

where http is the protocol, www.server.com is the designated computer and /dir1/dir2/resouce.htm designates the location of the resource on the designated computer.

Web servers host information in the form of Web pages; collectively the server and the information hosted are referred to as a Web site. A significant number of Web pages are encoded using the Hypertext Markup Language (HTML) although other encodings using the extensible Markup Language (XML) or the Standard Generic Markup Language (SGML) are becoming increasingly more common. The published specifications for these languages are incorporated by reference herein. Web pages in these formatting languages may include links to other Web pages on the same Web site or another. As will be known to those skilled in the art, Web pages may be generated dynamically by a server by integrating a variety of elements into a formatted page prior to transmission to a Web client. Web servers and information servers of other types await requests for the information that they receive from Internet clients.

Client software has evolved that allows users of computers connected to the Internet to access this information. Advanced clients such as Netscape's Navigator and Microsoft's Internet Explorer allow users to access software provided via a variety of information servers in a unified client environment. Typically, such client software is referred to as browser software.

The Internet may serve as one exemplary communications infrastructure for use in connection with the service chain management automation according to the present invention, as described in greater detail below. The entire service chain encompasses the entire process from an end user identifying a problem with a device to the return of the repaired device, or a replacement device where repair is either not feasible or cost effective.

One aspect of the overall service chain is the diagnosis of the problem with the device. For many electronic devices or other types of items, such as mobile phone handsets, diagnostic instruments, or analyzers, are connected to the device and perform one or more tests. Technicians use analyzers to run a series of tests against a phone that is in for repair. Theses tests are diagnostic in nature and will look at various system functions within the phone to enable the technician to determine where problems exist with the phone.

A series of one or more individual tests is called a script. A manufacturer, carrier, Authorized Service Center (ASC) or re-manufacturer may build a series of scripts for each phone type. A technician will determine what script to use to test the phone depending on the problem reported with the phone. A technician can run multiple scripts against a phone when looking for problems, or they may run one script and then several individual tests to get clarification of the problem.

A variety of analyzers such as those manufactured by companies such as Agilent, Anritsu, and Acterna are used in the mobile phone industry to test handsets that are returned for repair. The analyzers are used to discover problems with the electronic and software components of a handset. The data readouts from each test on a handset are of huge value to the repair technician to make an immediate diagnosis of non-visible problems with the phone. However, as there is no existing method to trap and warehouse this data, aggregation of the data is not typically done.

An additional problem faced by users of the analyzers is getting timely updates to the test scripts that are used to test each phone. A test script may specify one or more tests to be performed by the analyzer on a malfunctioning device. The required tests and the pass/fail limits of the tests are set by the manufacturers, who then rely on the analyzer manufacturers to distribute updated software containing the new scripts to all users. This is at best done haphazardly. A centralized location for updated scripts, or a better method of gaining access to updated scripts is highly desired.

The systems and methods according to the present invention address these and other issues related to diagnostic procedures in present service chains.

### SUMMARY OF INVENTION

The present invention relates to systems and methods for automating the tracking and monitoring of the repair process via automated malfunction analysis, diagnostic interface standardization, centralized maintenance and distribution of test scripts used by diagnostic devices and aggregation of analysis test data. A typical system according to the present invention may include a system processor and a system data store. In certain embodiments, the system processor may be used to implement methods according to the present invention. Further, computer-readable media, such as magnetic and optical disks, primary storage devices such as RAM and ROM, etc., may be used to store instruction that cause a computer to execute methods according to the present invention.

According to the present invention, diagnostic data is received from one or more diagnostic devices and, in some embodiments, may be stored in a data store. Diagnostic data may be sent in response to polling by a centralized system processor or as initiated by individual diagnostic devices. Reports analyzing a subset of the diagnostic data received are generated and outputted. Typically, reports will be based upon item type, malfunction type, diagnostic device type, item manufacture and/or test/tests performed. Reports may be generated either in response to a report request or other trigger event or at periodic intervals.

In some embodiments, one or more system diagnostic devices may be included in the system in addition to, or instead of, diagnostic devices communicating with an aggregation and reporting environment according to the present invention. Typically, such system diagnostic devices will include a testing element or device responsible for performing tests on malfunctioning items, a diagnostic processor that communicates diagnostic data from the testing device to the system processor, and, in some cases, a diagnostic data store that temporarily or permanently stores data generated by the testing device.

Further, in addition to diagnostic data, scripts containing instructions for use by diagnostic devices for running tests may be accessed and/or generated via a central location in some embodiments. In certain system embodiments, the scripts may be stored either a separate script data store and/or as a portion of a system data store. Generation of new scripts may be accomplished in some particular embodiments; such new scripts may be generated based upon existing scripts, typically supplied, at least initially, by diagnostic device manufacturers, and upon diagnostic data accumulated from the diagnostic devices. Scripts, either newly generated or preexisting, may be distributed to diagnostic devices via the present invention.

In another aspect of the present invention, centralized management of diagnostic devices may also include development and distribution of standardized interface for driving diagnostic devices by diagnostic technicians. Such interfaces would be independent of specific diagnostic device manufacturer but might depend upon the type of item being tested and/or the symptoms exhibited by the item being tested. In one embodiment, standardization may be accomplished through instruction contained within scripts distributed via the present invention. Scripts could be interpreted by software local to a specific diagnostic device which would generate an interface for driving the specific diagnostic device. Benefits derived from such a standardization of interface include commonality of test names across all item models within a given item type, ensuring that only the most up-to-date scripts are being used on analyzers by removing the issues around manually updating analyzer software and script data and giving consistent interfaces to users independent of the analyzer is being used and, in some embodiments, independent of the model of the item being tested.

The data aggregated according to the present invention is valuable to all parties involved in the repair of the malfunctioning item. In the instance where the item subject to repair is a mobile phone, the data will be useful for carriers, authorized service centers (ASCs) and manufacturers. For carriers, the aggregated failure data may be used during negotiations with manufacturers, as support for warranty claims and to more accurately project future work flows. For ASCs, the aggregated failure data may be used as support for warranty claims and to more accurately project future work flow. For manufactures, the aggregated data may be used to improve customer service by providing faster payout of warranty claims, to improve warranty claim submission accuracy from customers and suppliers, to obtain faster, more accurate failure data on particular item models, and to save money by not having to re-do tests already run by carriers/service centers. The ASC and manufacturer benefits may be realized for item types other than mobile phones.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF DRAWINGS

The accompanying drawings, which are incorporated in and constitute a part of this specification, illustrate one embodiment of the invention and together with the description, serve to explain the principles of the invention.

FIG. 1 is a diagram representing a system according to the present invention wherein diagnostic devices communicate with an aggregation and reporting environment via the Internet.

FIG. 2 is a diagram representing a system according to the present invention wherein diagnostic devices are a part of the local communication network of the aggregation and reporting environment.

FIG. 3 is a diagram representing a system according to the present invention wherein diagnostic devices are both within and without the local communication network of the aggregation and reporting environment.

FIG. 4 is a flow chart of the process of transferring test data from a diagnostic device to an aggregation server in a typical push embodiment.

FIGS. 5-8 depict example reports that might be generated by an environment according to the present invention.

### DETAILED DESCRIPTION

Preferred embodiments of the invention are now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

The description below describes analyzers used in the mobile phone industry; however, this specific item type is to be taken as exemplary. It will be apparent to those of skill in the art that the principles involved with analyzers for a particular item type will apply equally to analyzers for other types of devices including, without limitation, computers; hand-held electronic devices such as personal data assistant devices, pagers, calculators, clocks, radios, etc.; automobile components; medical devices; networking communications equipment such as switches, routers, modems, broadband communication enabling devices, etc.; standard telephones; televisions; or other similar devices, particularly computer controlled devices.

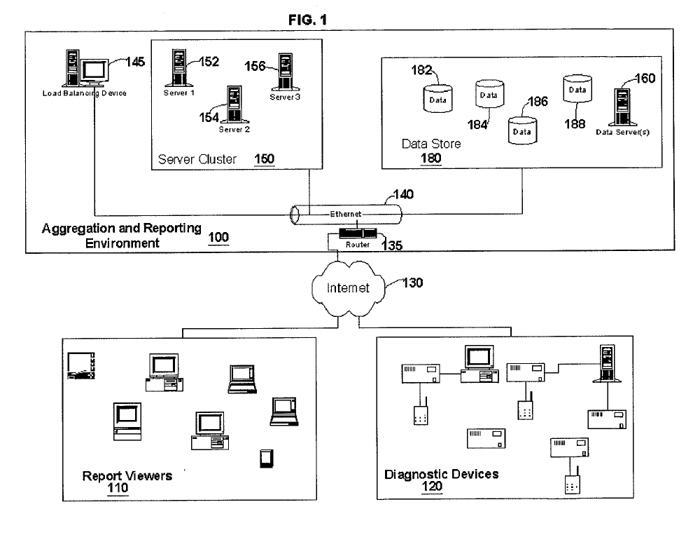

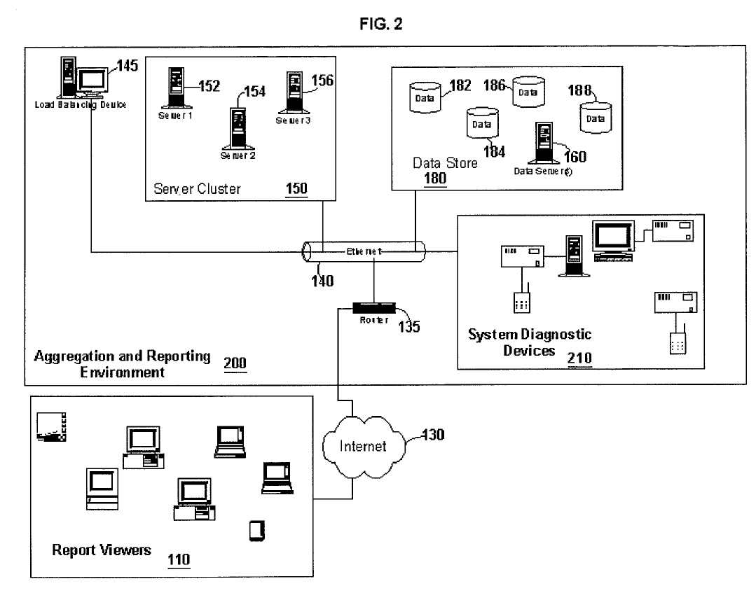

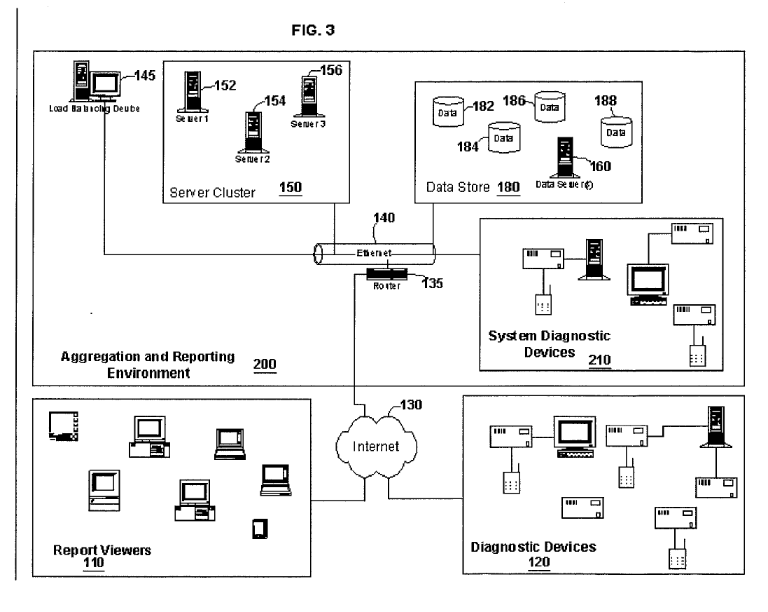

Variations on typical environments according to the present invention are seen in FIGS. 1-3. FIG. 1 diagrammatically represents an aggregation and reporting environment 100 servicing as a diagnostic device data aggregation and management center where diagnostic devices 120 do not participate in the local communication network 140 of the environment 100. This arrangement would be typical of an embodiment of the present invention wherein aggregation, reporting and management services were provided on an Application Service Provider (ASP) basis. One or more diagnostic device owners would outsource the management of owned diagnostic devices 120 to the ASP providing services via environment 100. Alternative, FIG. 1 could also be used by a large organization having diagnostic devices located at geographically and/or logically diverse locations. The variation of FIG. 2 provides an environment 200 similar to that of FIG. 1; however, diagnostic devices 210 form a part of the environment 200. As depicted, such diagnostic devices 210 could participate in the same communications network 140 as the remainder of the environment. Finally, FIG. 3 depicts a combined variation of FIGS. 1 and 2 where diagnostic devices 120, 210 appear both within and without the environment 200. P Referring to FIGS. 1-3, diagnostic device management and data aggregation and reporting environments 100, 200 may include a server cluster 150 of one or more servers (e.g. 152, 154, 156) that provides management, aggregation and reporting functionality. These or other servers may support access by users requesting and/or reviewing reports 110 and by diagnostic devices 120, 210. Access to the environment by these various users/devices may be via any suitable communication channel, which in a typical embodiment will be a computer network such as the Internet 130 and/or Ethernet 140. In other environments, access may be via other forms of computer network, direct dial-up connection, dedicated connection, or other suitable channel as would be known to those skilled in the art. In some embodiments the access channel may provide security features; for instance, a secure socket layer (SSL) may be used with respect to an embodiment using the Internet 130 as the access communication channel. The one or more servers may include or connect to a data store 180 for storing aggregated data, and in some embodiments, scripts for the environment.

The various components of the environment 100, 200 may communicate with each other through any suitable communication architecture including, but not limited to, a computer network such as a Ethernet 140, token ring network or the Internet 130; a direct connection such as a bus connection, parallel or serial connection, null modem connection or wireless connection utilizing an appropriate communication protocol such as BLUETOOTH; and a dial-up connection. In embodiments where a single computer may provide all functional components, the communication may occur via bus connections, inter-process communication, shared files or some combination of these methods or other commonly utilized communication mechanisms.

The architecture seen in FIGS. 1-3 use the Internet 130 and an Ethernet 140 as communication channels allowing access to the environment by various users 110 and diagnostic devices 120, 210. The environments uses a computer network such as the depicted Ethernet 140 to allow communication among the components of the environment; a router 135 is included in the environment to manage such communication within the internal network as well as managing the interface between the internal network and the Internet 130. The functionality of the environment is spread among a server cluster 150, a data store 180 and, in some embodiments, a load balancing device 145. Where a load balancing device 145 is present, the device may be responsible for allocating and managing distribution of access among various elements within the server cluster 150 and/or the data store 180. Users may access the environment through standard Web browser software or via specialized access software adapted for interfacing with the aggregation and reporting environment 100, 200.

In some embodiments, diagnostic devices 120 simply communicate with the environment 100. Whereas in others, diagnostic devices 210 form a part of the environment 200; in some such embodiments, additional diagnostic devices 120 may also communicate with the environment 210. In FIGS. 1-3, the communication by diagnostic devices 210 within the environment is shown as via Ethernet while communication by diagnostic devices 120 outside the environment 100, 200 is shown as via the Internet. It will be understood that the invention is not limited to this mode of communication; rather, diagnostic devices 120, 210 whether within or without the environment 100, 200 may utilize any suitable communication channel including those describe above with respect to intercomponent communication within the environment 100, 200. The diagnostic devices may be in constant or intermittent communication with one or more servers in the environment. Communication may be initiated by any of the diagnostic devices depending upon circumstances or by other elements within the environment, particularly servers within the server cluster.

The server cluster 150 provides the aggregation and reporting functionality of the environment 100, 200. In one embodiment, the server cluster 150 may be divided into access servers and application servers where the access servers provide electronic access functionality such as by electronic mail server(s) and/or Web server(s) and the application servers provide the aggregation, analysis and reporting functionality. In one embodiment, the one or more servers (e.g. 152, 154, 156) in the server cluster 150 may be supported via Intel-compatible hardware platforms preferably using at least a PENTIUM III class microprocessor (Intel Corp., Santa Clara, Calif.). The hardware platform would have an appropriate operating system such as WINDOWS 2000 Server (Microsoft, Redmond, Wash.), WINDOWS/NT Server (Microsoft, Redmond, Wash.), Solaris (Sun Microsystems, Palo Alto, Calif.), or LINUX (or other UNIX variant). Depending upon the hardware/operating system platform, appropriate server software may be included to support the desired application, email and Web server functionality. In one embodiment, the Web server functionality may be provided via an Internet Information Server (Microsoft, Redmond, Wash.). The email services may be supported via an Exchange Server (Microsoft, Redmond, Wash.). Application servers in some embodiments may be iPlanet Application Servers (iPlanet E-Commerce Solutions-A Sun-Netscape Alliance, Mountain View, Calif.), WebSphere Servers (International Business Machines, Armonk, N.Y.) or Citrix MetaFrame (Citrix Systems, Inc., Ft. Lauderdale, Fla.). In one embodiment, the business application services may be provided through programmed pages on the Web server; such pages may use ActiveX, VBScript, Java Applet and/or Servelet technology to provide server side business logic and may use ActiveX or JavaScript to support client side business logic.

The data store 180 provides for the storage and, potentially, the management of the data required by the environment. A typical data store will include one or more storage devices (e.g. 182, 184, 184, 186), and in some embodiments, may include one or more data servers (e.g. 160). Information concerning different users, information related to diagnostic devices and aggregated diagnostic data are stored in the data store 180. The architecture of the data store 180 may vary significantly in different embodiments. In several embodiments, database(s) are used to store and manipulate the data; in some such embodiment, one or more relational database management systems, such as SQL Server (Microsoft, Redmond, Wash.), ACCESS (Microsoft, Redmond, Wash.), ORACLE 8i (Oracle Corp., Redwood Shores, Calif.), Ingres (Computer Associates, Islandia, N.Y.), or Adaptive Server Enterprise (Sybase Inc., Emeryville, Calif.), in connection with a variety of storage devices/file servers. In other embodiments, the data store 180 may use database systems with other architectures such as object-oriented, spatial, object-relational or hierarchical or may use other storage implementations such as hash tables or flat files or combinations of such architectures.

Diagnostic devices 120, 210 whether part of the aggregation environment or simply communication with it will include a testing component used to perform tests on a malfunctioning item. In some embodiments, diagnostic devices 120, 210 may include a diagnostic processor and/or a diagnostic data store. A single diagnostic processor and/or a single diagnostic data store may be shared across multiple diagnostic devices in some instances. Diagnostic device may also in certain instance include or have associated with them a diagnostic display device for displaying an interface for driving the diagnostic device, for displaying test results and/or for displaying reports on aggregated data generated according to the present invention. The testing component/device typically is responsible for running one or more tests on an item of a specific test item type. The resultant test data may be stored temporarily or permanently in a diagnostic data store if present; the test device or the diagnostic processor may be responsible for placing the test data in the appropriate diagnostic data store.

Aggregation of data occurs through the transfer of data from diagnostic devices 120, 210 to a processor within a server (e.g. 152) of the server cluster 150 inside aggregation and reporting environment 100, 200. In different embodiments, the transfer of data may be in initiated exclusively from pulling by a server 150, exclusively from pushing from the diagnostic devices 120, 210, or a combination of pulling and pushing.

In push based embodiments, diagnostic devices 120, 210 initiate aggregation of data by sending data to a server in the server cluster 150. If the embodiment is purely push based, transmission of data is independent of prompting from the receiving server. Diagnostic devices 120, 210 may typically include a diagnostic processor responsible for transmitting the data as it is developed, upon demand or at scheduled periodic intervals. The transfer may be accomplished via a server running on such a diagnostic processor, such as an email server set to send data files using SMTP protocol. In another environment, a specialized client may be used to transfer the data via a server running on one or more of the server systems in the server cluster 150. Typical examples would be a Web server and/or an FTP server where the specialized client running on the diagnostic processor would transfer data files using a POST method transfer (HTTP or HTTPS) or a PUT command, respectively. In some embodiments, raw data from the analyzer may be sent. In other embodiment, a diagnostic processor may receive the raw data and convert it into a more appropriate format such as HTML, XML, XSL, SGML, some combination thereof, or other suitable format. In some embodiments, the data may be stored locally in a diagnostic data store in either raw or formatted form. Such storage may be for temporary intervals such as until transferred to the aggregation environment or a fixed time period or on a more permanent basis.

In pull based embodiments, a server (e.g. 152) within the server cluster 150 of the aggregation and reporting environment 100, 200 pulls data from the diagnostic devices 120, 210. If the embodiment is purely pull based, transmission of data is independent of prompting from the diagnostic devices 120, 210. Some pull based embodiments may include a diagnostic processor controlling and supporting one or more diagnostic devices 120, 210. The diagnostic processors may support a server for receiving requests from a server in the server cluster 150. Such servers may be Web servers, FTP servers, GOPHER servers, WAIS servers, email-based file retrieval server, or other suitable server software for transmitting data files in response to a request. In other embodiments, diagnostic devices 120, 210 may store data to a diagnostic data store directly accessible by the aggregation environment 100, 200. A system processor within a server of the server cluster 150 may pull test data in various ways. In some embodiments, polling of diagnostic devices may occur at periodic intervals. In addition, or alternatively, polling may result from the receipt of a request for a report aggregating test data. In one particular embodiment, diagnostic devices 120, 210 may store data locally in a diagnostic data store accessible to their own Web servers and exposed programmatically (rather than visually) for periodic collection using a Web Service approach such as Microsoft's forthcoming NET technology. In some embodiments, raw data from the diagnostic device 120, 210 may be pulled. In other embodiment, a diagnostic processor may receive the raw data and convert it into a more appropriate format such as HTML, XML, SGML or other suitable format. In some embodiments, the data may be stored locally in a diagnostic data store in either raw or formatted form. Such storage may be for temporary intervals such as until pulled by the aggregation environment or a fixed time period or on a more permanent basis.

In a particular push embodiment, a software product is associated with each diagnostic processor associated with one or more diagnostic devices 120, 210. The software product may reside in any computer readable storage media. While in use this software will reside in a computer readable storage media accessible to each respective diagnostic processor such as a diagnostic store that may include one or more forms of primary storage such as cache memory, Random Access Memory (RAM) or Read Only Memory (ROM) and/or one or more forms of secondary storage such as removable or fixed, optical or magnetic disk, paper or magnetic tape or punch card.

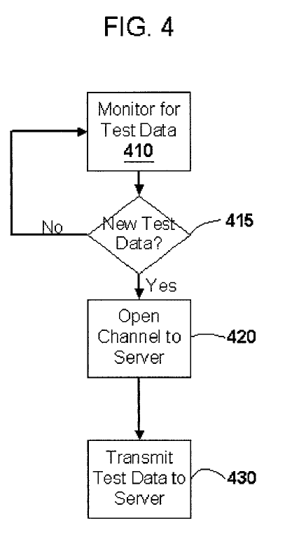

FIG. 4 depicts the process performed by this software product. In step 410, the software product monitors for test data. A determination is made whether new test data is available or not in step 415. If test data is not available, the software continues to monitor for test data at step 410. If test data is available, a connection is established to a server in the server cluster 150 in step 420. After the connection is established, the software transmits the data to the server via the established connection in step 430.

In step 410, the software may monitor for test data in several ways. In one embodiment, the software monitors one or more locations of one or more diagnostic data store for the appearance of test data. If the diagnostic processor is associated with multiple diagnostic devices, the software product may monitor multiple locations within the diagnostic data store or multiple diagnostic data stores; alternatively, multiple instantiations of the software product may run on a single multitasking diagnostic processor where each instantiation monitors one or more locations in one or more diagnostic data stores. Test data may be placed in an appropriate location in a diagnostic data store either directly by the testing component of a particular devices or indirectly where the testing component communicates the test data to a diagnostic processor which places the received test data in the diagnostic data store. In other embodiments, the software may monitor the testing element directly for generation of test data. Again, if multiple diagnostic devices are associated with the diagnostic processor, the software may monitor multiple associated diagnostic devices and/or run multiple instantiations of the software where each instantiation monitors one or more of the multiple diagnostic devices.

In step 415, a determination is made as to whether new test data is available for transmission to the server. The check may occur at periodic intervals or upon demand from another source such as the testing component of a diagnostic device. The check may be, in one embodiment, a check on a directory to determine if a data file has been placed in it. In another embodiment, the determination may be made by examining a communication channel associated with the one or more testing elements.

If test data is available to be pushed, a connection is established with a server in the server cluster 150 in step 420. Typically, the connection will be over a computer network such as Ethernet 140 or the Internet 130; however, in other embodiments, the connection could be established via another form of computer network such as a token ring network; a direct connection such as a bus connection, parallel or serial connection, null modem connection or wireless connection utilizing an appropriate communication protocol such as BLUETOOTH; and a dial-up connection. In embodiments where a single computer may provide all functional components of both the server cluster 150 and the diagnostic processor, the communication may occur via bus connections, inter-process communication, shared files or some combination of these methods or other commonly utilized communication mechanisms.

Once the communication channel is established, the data is transferred in step 430. In one embodiment, the software product acts as a specialized Web client communicating with the server via the HTTP protocol. In such an embodiment, the client may transfer the data using a POST method request of the test data. In some circumstances, the test data, or portions thereof, could be transferred as parameters of a GET method request; however, this approach is more limited than the POST method. As an alternative, the software product may act as an FTP client and transfer the test data via a PUT command to an FTP server running in the server cluster 150.

Data in the environment may be accessed via reports. Typically, reports will be generated by a server (e.g. 154) from the server cluster 150. Report generation may occur as a result of a variety of circumstances. Reports may be generated upon demand such as via a request by a report viewer 110 or an automated system such as a warranty claim submission and tracking subsystem or a script generation system, both described in greater detail below. In addition, reports may be generated on a periodic basis.

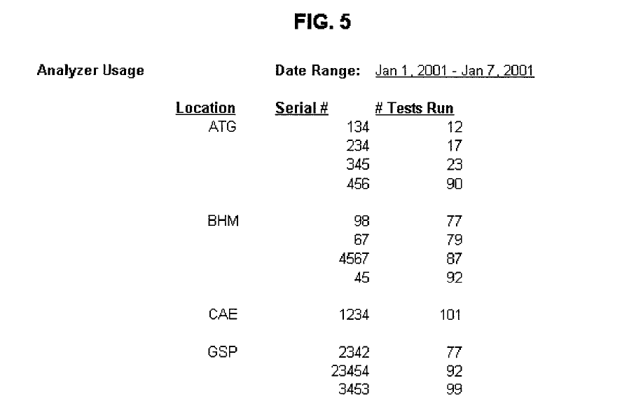

Reports may be generated based upon a variety of criteria associated with the data. The reports could use criteria such as item type being tested, malfunction type, diagnostic device type, item manufacturer and specific test performed. FIGS. 5-8 present some reports that could be generated in typical embodiments. These sample reports will typically cover a specific range of time, which, in some embodiments, may be selected or specified by a report requester.

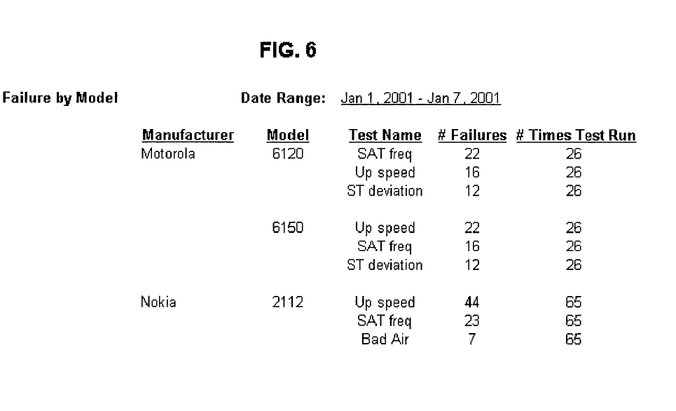

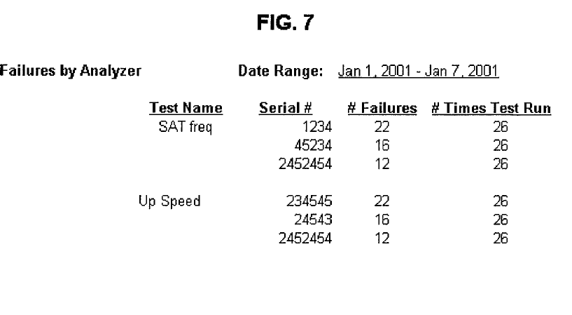

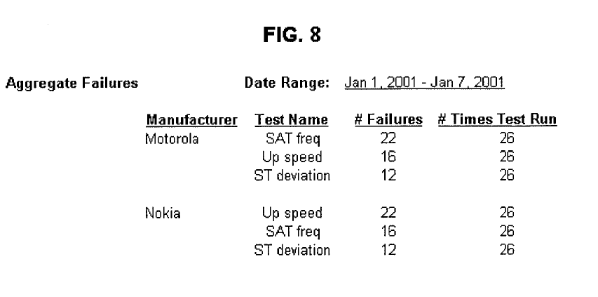

FIG. 5 depicts a sample report of analyzer usage showing diagnostic devices by location and reporting number of tests performed by individual devices. FIG. 6 is a sample report providing a report on malfunctions broken down by item type model. in this sample, the item type is mobile phones, the report is further organized by item manufacturer as well as specific model. FIG. 7 shows a sample report displaying data on results of particular tests organized by diagnostic device. The final example, FIG. 8, displays a report aggregating failures by item manufacturer, where listings for each manufacturer are organized by test performed.

In some embodiments, report viewers 110 can contact an access server in the server cluster 150 to request a report. The access server in question will typically be a Web server; however, in some embodiments, the access server may be an email server, WAIS server, GOPHER server or FTP server. Generated reports may be outputted to requesting report viewers via the appropriate access server in the server cluster 150. The request for the report from a report viewer 110 may, in certain embodiments, be the event that causes the report generation. In other embodiments, requests simply access previously generated reports without necessarily serving as the impetus for generation. Report viewers 110 need not be the only type of report recipient. Reports may, in some embodiments, be requested from and/or received by a diagnostic device selected from those communicating with the server. Reports may also be requested and/or received by other automated systems that further process and/or analyze the generated report.

Outputted reports may be formatted in an appropriate output format such as an appropriate formatting language (e.g. HTML, XML, SGML, XSL, combinations thereof, etc.) or an industry standard format (e.g. spreadsheet (Excel, Lotus, etc.), word processing (Word, WordPerfect, etc.), database (e.g. DB2, Access, SQL, etc.) or electronic document (e.g. PDF). The output report will be received by the recipient and displayed using a user display device such as a printer, facsimile, end user computer or a display device associated with one of the diagnostic devices 120, 210, processed further or both.

Reports may also be outputted directly to automated processing systems such as a warranty claim submission, analysis and/or tracking system or subsystem, insurance claim processing system and/or a script generation system. In these cases, the generated report is received by the particular automated system and processed further. Reports may be outputted for further processing in commercially available spread sheet, word processing and/or database applications.

Finally, reports may be distributed in an automated fashion. Specific recipients may be associated with particular report types. Upon generation of a report of the particular report type, a copy is distributed to all designated recipients. Report delivery may be accomplished via any suitable delivery platform including without limitation electronic mail, facsimile, remote printing, etc.

In some embodiment of the present invention, centralized management of diagnostic devices may also include development and distribution of standardized interface for driving diagnostic devices by diagnostic technicians. Such interfaces would be independent of specific diagnostic device manufacturer but might depend upon the type of item being tested and/or the symptoms exhibited by the item being tested. In one embodiment, standardization may be accomplished through instruction contained within scripts distributed via the present invention.

In script managing embodiments, a script data store will typically be present at the centralized authority for storing scripts for dissemination or retrieval. Such embodiments may have a similar form to those depicted in FIGS. 1-3. In such embodiments, the script data store may be a part of the system data store 180 or may be separate. A separate script processor, communicating with the script data store and/or the system data store as well as the diagnostic devices 120, 210 that are already in communication with a system processor of the server cluster 150, may also be part of a typical system; alternatively, a system processor in a server (e.g. 156) of the server cluster 150 may provide this functionality in certain embodiments.

Scripts could be interpreted by software local to a specific diagnostic processor associated with one or more diagnostic devices, which would generate an interface for driving the specific diagnostic device. Typically, the interface would be presented via a diagnostic display in communication with the diagnostic processor. In some instances, the diagnostic processor and display could be components of a computer system used to control one or more diagnostic devices. In other embodiments, the diagnostic processor, the diagnostic display or both could be physically integrated into a specific diagnostic device. Benefits derived from such a standardization of interface include commonality of test names across all item models within a given item type, ensuring that only the most up-to-date scripts are being used on analyzers by removing the issues around manually updating analyzer software and script data and giving consistent interfaces to users independent of the analyzer is being used and, in some embodiments, independent of the model of the item being tested.

Script management within such embodiments may occur in push, pull or combined push-pull embodiments. Push embodiments involve dissemination of scripts from a centralized script authority independent of individual diagnostic devices. Pull embodiments involve individual diagnostic devices retrieving scripts from a centralized script authority independent of events at the script authority. Combined embodiments may use aspect of both push and pull embodiments.

In push based embodiments, centralized script authority initiate script dissemination by sending data to one or more diagnostic devices. In embodiments using an architecture as depicted in FIGS. 1-3, the centralized script authority functionality may be provided by a server (e.g. 156) of the server cluster 150 in connection with the system data store 180. In other embodiments, the processing and/or data storage functionality, however, may be accomplished via other components not depicted. If the embodiment is purely push based, transmission of data is independent of prompting from the receiving diagnostic devices. Diagnostic devices may typically include a diagnostic processor responsible for receiving the script data. The centralized script authority may transmit scripts to diagnostic devices either periodically or as the result of some server based event such as an update to the scripts in the script data store. The transfer may be accomplished via a server running on a system associated with the centralized script authority, such as an email server set to send data files using SMTP protocol. In another environment, a specialized client may be used to transfer the data via a server running on one or more of the diagnostic devices. Typical examples would be a Web server and/or an FTP server where the specialized client running at the centralized authority would transfer data files using a POST method transfer (HTTP or HTTPS) or a PUT command, respectively. In addition, the centralized script authority may provide multiple methods for dissemination of scripts. In such embodiments, each diagnostic device may designate one or more methods for receiving the script data. These designated methods may have preference levels defining the most/least preferred method of script delivery. In a typical push base embodiment, a data store at the centralized authority may be used to store information associated with each diagnostic device. Such information may include script delivery method preference, device manufacturer and item type for which the device may be used. The centralized authority may, in a typical embodiment, use this information for selective dissemination of scripts to specific diagnostic devices rather than broadcasting all script updates to all devices.

In pull based embodiments, each diagnostic device would be responsible for pulling scripts from the centralized script authority. If the embodiment is purely pull based, transmission of data is independent of prompting from the centralized authority. Some pull based embodiments may include a diagnostic processor controlling and supporting one or more diagnostic devices. The centralized script authority may support a processor with a server (e.g. 156 in FIGS. 1-3 or as separate component (not shown)) for receiving requests from diagnostic devices and transmitting scripts in response to such requests. Such servers may be Web servers, FTP servers, GOPHER servers, WAIS servers, email-based file retrieval server, or other suitable server software for transmitting script files in response to a request. In other embodiments, the centralized authority may store scripts to a data store directly accessible to the diagnostic devices. A diagnostic device may pull scripts in various ways. In some embodiments, polling of the centralized authority may occur at periodic intervals. In addition, or alternatively, polling may result from some event local to the diagnostic device such as invocation of a local software product that interfaces with the testing device and/or connection of an item for testing. In one particular embodiment, central authority may store scripts locally in a data store accessible to their own Web servers and exposed programmatically (rather than visually) for periodic collection using a Web Service approach such as Microsoft's forthcoming .NET technology. Typically, diagnostic devices will request only those scripts that apply to themselves; however, in some embodiments, all scripts may be requested and received at which point the receiving diagnostic device may sort through the received scripts for those that are applicable.

In a particular pull based embodiment, software resides locally at each diagnostic processor. The software may act as a specialized Web client that transmits a request either periodically and/or upon occurrence of specific events (e.g. opening the local software, connection of a test item to the testing element of a diagnostic device associated with the diagnostic processor, user selecting an update script option in the software, etc.) an HTTP or HTTPS GET method request to a Web server run by a centralized script authority. The GET method request may in certain embodiments include parameters and/or cookie data designating information about diagnostic devices associated with the particular diagnostic processor; in other embodiments, the identity of the diagnostic processor originating the request may serve as a key for the Web server to access information locally about diagnostic devices associated with the particular diagnostic processor. The information may provide the server with the ability to select which scripts to transmit in response to the request. The local software may use the received scripts as a basis to generate an interface for presentation on a diagnostic display device associated with a particular diagnostic device that allows a technician to drive the particular diagnostic device to perform the scripted tests on a connected test item; in many case, the test item type and/or malfunction symptoms may also be used by the local software in the interface generation. The test item type may include generic type information as well as specific manufacturer and/or model information. In some instances, the interface may be generated independently of the specific manufacturer of the particular diagnostic device.

In another potential embodiment, the centralized script authority may be responsible for on-demand interface generation. In one such embodiment, local software on the diagnostic processor acts as either a specialized Web client or as a plug-in into standard browser software. The local software supports communication with the centralized script authority, the testing device, the diagnostic display, and a diagnostic data store when present. Upon receiving item type information and/or malfunction symptom information from the testing device, user data entry or both, the local software communicates information relevant to interface generation to the centralized authority using a Web server and HTTP to support the communication. The Web server at the centralized authority uses an application server to generate either the standardized interface, or a script enabling the local software to generate the standardized interface, based upon the communicated information relevant to interface generation. In some embodiments, the aggregate test data may be used to modify pre-existing static scripts based upon statistical analysis of data with respect tot he communicated information. The Web server can then return the interface as a standard HTML document. Alternatively, the Web server could transmit an XML document containing information needed by the local software to generate the final interface.

Some embodiments supporting script management may also provide script generation/modification capabilities. Typically, scripts will be received from manufacturers of devices and/or authored based upon preconceived expectations of malfunctions that may occur. The aggregated diagnostic data along with such original scripts may be used to modify existing scripts or generate new scripts that take into account the realities statistically represented by the aggregated data. Such new/modified scripts may be disseminated to diagnostic devices, and potentially stored for future use/revision, by a centralized script authority as described above. The generation/modification may be provided by the script and/or system processors described above with respect to dissemination of scripts. In a push embodiment, generation of a new/modified script may serve as the trigger for dissemination of the generated script to all relevant diagnostic devices.

In some such embodiments, script generation/modification is performed to optimize test performance for items of a given manufacturer and/or manufacturer model. Aggregated diagnostic data is analyzed to determine the most frequent malfunction according to item manufacturer/model. A new script is generated for testing an item of the particular item manufacturer/model wherein the tests for the most frequently occurring malfunction occur earlier in the scripted testing process. Where a script exists for a particular item manufacturer/model, the existing script may be modified rather than a new script being created. The new or modified script would then be available for dissemination to relevant diagnostic devices according the push or pull models described above.

Each analyzer manufacturer may use a language to specify scripts. In the field of mobile telephone handset testing SCPI is one such language; several manufacturers have created particular dialects for use with their respective diagnostic devices. Reference to SCPI, or handset test languages generally, is purely exemplary; the principles will apply equally well for test languages used with diagnostic devices designed for use with other test item types. The administrator at the centralized script authority can manually create a script by stringing together SCPI commands to produce a test plan that tests a handset for specific functionality. Each SCPI command produces a result. Once the script is generated, the administrator typically stores the scripts in a repository such as the script data store described above. New scripts can be assigned to individual diagnostic devices on an as needed basis or provided as periodic updates. Likewise, existing scripts can be modified in a manual or automated manner.

In some embodiments, the aggregation and reporting environment according to the present invention may be used in connection with an automated warranty submission, processing, tracking and management environment such as described in provisional U.S. patent application Ser. No. 60/241,898, filed Oct. 20, 2000, entitled “Service Chain Management Automation Systems and Methods.” Test data for individual items as well as the aggregated test data may be used in such a warranty environment.

Such a warranty processing component could be used to capture data required for submission of a warranty claim by each manufacturer during the process of repair. The warranty system functionality ensures that all the custom information, codes, etc. for each different mfg is captured at the point of repair. This data is then aggregated for submission to original equipment manufacturers (OEMS) for payment of warranty claims. If diagnostic data were submitted along with a claim, it would help the manufacturer validate the claim. In one embodiment, manufacturers may access the data from a central location via a suitable interface such as the Web. In such an embodiment, a typical architecture might include the various functional components depicted in FIGS. 1-3 using servers in the server cluster 150, or other servers (not shown) to perform the requisite warranty submission, processing, tracking and management functionality. Access server functionality could also be provided by servers in the server cluster 150, or other servers (not shown).

In some embodiments, the aggregation and reporting environment according to the present invention may serve as a component within an automated service chain management system such as described in provisional U.S. patent application Ser. No. 60/241,898, filed Oct. 20, 2000, entitled “Service Chain Management Automation Systems and Methods.”

Throughout this application, various publications may have been referenced. The disclosures of these publications in their entireties are hereby incorporated by reference into this application in order to more fully describe the state of the art to which this invention pertains.

The embodiments described above are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

What is claimed is:

1] A diagnostic data aggregation and reporting system supporting analysis of diagnostic data from one or more client diagnostic devices, the system comprising:
a) a system data store that stores diagnostic data; and
b) a server processor in communication with the system data store and one or more client diagnostic devices, wherein the server processor:
i) receives a diagnostic data set from a client diagnostic device, wherein the diagnostic data set represents results from the client diagnostic device running one or more tests on a test item having a test item type;
ii) stores the received diagnostic data set in the system data store;
iii) generates a report analyzing a subset of data from the system data store; and
iv) outputs the generated report.

2] The system according to claim 1, wherein the system data store has an architecture selected from the group consisting of flat file, hash table, database and combinations thereof.

3] The system according to claim 2, wherein the system data store has a database architecture.

4] The system according to claim 3, wherein the database architecture has an organization selected from the group consisting of object-oriented, relational, spatial, hierarchical, object-relational and combinations thereof.

5] The system according to claim 1, and further comprising:
c) one or more system diagnostic devices, wherein the one or more system diagnostic devices are a subset of the client diagnostic devices in communication with the server processor.

6] The system according to claim 5, wherein the each of the one or more system diagnostic devices comprises:
i) a testing device that runs one or more tests on a test item having a test item type; and
ii) a diagnostic processor that transmits diagnostic data sets resulting from test runs performed by the testing device to the server processor.

7] The system according to claim 6, wherein each of the one or more system diagnostic devices further comprises:
iii) a diagnostic data store that stores diagnostic data sets resulting from test runs performed by the testing device associated with each respective system diagnostic device.

8] The system according to claim 7, wherein the diagnostic processor of each system diagnostic device stores diagnostic data sets resulting from test runs performed by the respective testing device in the respective diagnostic data store.

9] The system according to claim 7, wherein the testing device of each system diagnostic device stores diagnostic data sets resulting from test runs performed by the respective testing device in the respective diagnostic data store.

10] The system according to claim 7, wherein the diagnostic processor of each system diagnostic device monitors the respective diagnostic data store for appearance of a previously untransmitted diagnostic data set and, upon appearance, transmits the previously untransmitted diagnostic data set to the server processor.

11] The system according to claim 6, wherein each of the one or more system diagnostic devices further comprises:
iii) a diagnostic display device in communication with the diagnostic processor that displays diagnostic data sets resulting from test runs performed by the testing device.

12] The system according to claim 11, wherein the diagnostic processor displays via the diagnostic display device a standardized interface for controlling the testing device, wherein the standardized interface is based upon the test item type of a particular item being tested.

13] The system according to claim 12, wherein the standardized interface is not based upon the testing device.

14] The system according to claim 12, wherein the standardized interface is further based upon a particular malfunction associated with the particular item being tested.

15] The system according to claim 12, wherein the diagnostic processor generates the standardized interface for display by communicating the test item type to the server processor, wherein the server processor upon receipt of the test item type creates the standardized interface and communicates the created standardized interface and wherein the diagnostic processor receives the created standardized interface.

16] The system according to claim 5, wherein the one or more system diagnostic devices are in intermittent communication with the server processor.

17] The system according to claim 17, wherein the server processor initiates intermittent communication with at least one of the one or more system diagnostic devices.

18] The system according to claim 17, wherein one of the one or more system diagnostic devices initiates intermittent communication with the server processor.

19] The system according to claim 5, wherein each system diagnostic device communicates with the server processor via a communication channel selected from the group consisting of computer network, direct serial or parallel connection, dial-up connection, wireless connection and bus connection.

20] The system according to claim 14, wherein the communication channel is the Internet.

21] The system according to claim 1, and further comprising:
c) a script data store that stores at least one script containing instructions for use by client diagnostic devices for running tests.

22] The system according to claim 21, wherein the script data store is in communication with the server processor and wherein the server processor communicates a script from the script data store to a selected subset of the one or more client diagnostic devices.

23] The system according to claim 22, wherein the server processor receives one or more scripts from one or more diagnostic device manufacturers and stores the received scripts in the script data store.

24] The system according to claim 22, wherein the server processor communicates at least one script on a periodic basis.

25] The system according to claim 22, wherein the server processor communicates a selected script from the script data store to a particular client diagnostic device from among the client diagnostic devices.

26] The system according to claim 22, wherein the server processor creates a new script for communication to a selected subset of the one or more client diagnostic devices, wherein the server processor creates the new script based upon a subset of diagnostic data in the system data store relevant to the selected subset of the one or more client diagnostic devices and an existing script in the script data store.

27] The system according to claim 26, wherein the server processor stores the created new script in the script data store.

28] The system according to claim 21, and further comprising:
d) a script processor in communication with the script data store and one or more script-client diagnostic devices; and
wherein the script processor communicates a script from the script data store to a selected subset of the script-client diagnostic devices.

29] The system according to claim 28, wherein the script processor creates a new script for communication to a selected subset of the one or more script-client diagnostic devices, wherein the script processor creates the new script based upon a subset of diagnostic data in the system data store relevant to the selected subset of script-client diagnostic devices and an existing script in the script data store.

30] The system according to claim 1, wherein the system data store comprises a script data store that stores at least one script containing instructions for use by diagnostic devices for running tests.

31] The system according to claim 30, wherein the server processor communicates a script from the script data store to a selected subset of the one or more client diagnostic devices.

32] The system according to claim 30, and further comprising:
c) a script processor in communication with the system data store and one or more script-client diagnostic devices; and
wherein the script processor communicates a script from the script data store to a selected subset of the script-client diagnostic devices.

33] The system according to claim 32, wherein the script processor creates a new script for communication to a selected subset of the script-client diagnostic devices, wherein the script processor creates the new script based upon a subset of diagnostic data in the system data store relevant to the selected subset of script-client diagnostic devices and an existing script in the script data store.

34] The system according to claim 30, wherein the server processor creates a new script for communication to a selected subset of the client diagnostic devices in communication with the server processor, wherein the server processor creates the new script based upon a subset of diagnostic data in the system data store relevant to the selected subset of client diagnostic devices and an existing script in the script data store.

35] The system according to claim 1, wherein the server processor polls one or more of the client diagnostic devices for new diagnostic data sets.

36] The system according to claim 35, wherein the server processor polls one or more of the client diagnostic devices on a periodic basis.

37] The system according to claim 35, wherein the server processor receives a request for a report and selectively polls one or more of the client diagnostic devices based upon the received request prior to generating the report.

38] The system according to claim 1, wherein the server processor receives the diagnostic data set in a format selected from the group consisting of XML, SGML, XSL, HTML and combinations thereof.

39] The system according to claim 1, wherein the server processor communicates with the client diagnostic devices via a communication channel selected from the group consisting of computer network, direct serial or parallel connection, dial-up connection, wireless connection, bus connection, and combinations thereof.

40] The system according to claim 39, wherein the communication channel is the Internet.

41] The system according to claim 1, wherein the server processor communicates with each client diagnostic device via a communication protocol selected from the group consisting of HTTP, HTTPS, FTP and SMTP.

42] The system according to claim 1, wherein the server processor receives a request for a report.

43] The system according to claim 42, wherein the received request comprises at least one criterion selected from the group consisting of item type, malfunction type, diagnostic device type, item manufacturer and specific test performed.

44] The system according to claim 1, wherein the server processor generates reports on a periodic basis.

45] The system according to claim 1, wherein the test item type is selected from the group consisting of hand-held electronic devices, medical devices and networking communications devices.

46] The system according to claim 45, wherein the test item type is a type of handheld electronic devices selected from the group consisting of mobile telephones, personal data assistants, and pagers.

47] The system according to claim 45, wherein the test item type is a type of networking communications devices selected from the group consisting of switches, routers, modems, and broadband communication enabling devices.

48] The system according to claim 1, wherein the server processor outputs the generated report to an end user display device.

49] The system according to claim 48, wherein the end user display device is selected from the group consisting of a printer, an end user computer, and a selected client diagnostic device.

50] The system according to claim 1, wherein the server processor outputs the generated report to a post-processing environment selected from the group consisting of a spreadsheet application, a database application, a test script development environment, a warranty claim processing environment, a warranty analysis processing environment and an insurance claim processing environment.

51] The system according to claim 1, wherein the one or more client diagnostic devices comprises a plurality of diagnostic devices.

52] A computer-readable storage device storing instructions that upon execution by a server computer cause the server computer to aggregate and report diagnostic data from one or more client diagnostic devices supporting analysis of such aggregated data by performing the steps comprising of:
a) receiving a diagnostic data set from a client diagnostic device, wherein the diagnostic data set represents results from the client diagnostic device running one or more tests on a test item having a test item type;
b) storing the received diagnostic data set in a data store;
c) generating a report analyzing a subset of data from the data store; and
d) outputting the generated report.

53] The storage device according to claim 52, and storing further instruction that upon execution by the server computer cause the server computer to perform the step comprising of:
e) transmitting a script from the data store to a selected set of client diagnostic devices, the script containing instructions for use by the selected set of client diagnostic devices in running tests on test items having a test item type.

54] The storage device according to claim 53, wherein the stored instructions that upon execution by the server computer cause the server computer to perform the step of transmitting a script comprise instructions that cause the server computer to transmit the script upon receipt of a request for an update from a particular client diagnostic device from among the selected set of client diagnostic devices.

55] The storage device according to claim 53, and storing further instruction that upon execution by the server computer cause the server computer to perform the step comprising of:
f) generating a new script from a subset of diagnostic data in the data store relevant to the selected set of client diagnostic devices and an existing script in the data store; and
wherein the stored instructions that upon execution by the server computer cause the server computer to perform the step of transmitting the script comprise instructions that cause the server computer to transmit the script upon generation of the new script.

56] The storage device according to claim 52, and storing further instruction that upon execution by the server computer cause the server computer to perform the step comprising of:
e) generating a new script from a subset of diagnostic data in the data store relevant to the selected set of client diagnostic devices and an existing script in the data store.

57] The storage device according to claim 56, and storing further instruction that upon execution by the server computer cause the server computer to perform the step comprising of:
f) storing the new script in the data store.

58] The storage device according to claim 52, and storing further instruction that upon execution by the server computer cause the server computer to perform the step comprising of:
e) polling one or more client diagnostic devices for new diagnostic data sets.

59] The storage device according to claim 52, wherein the stored instructions that upon execution by the server computer cause the server computer to perform the step of outputting the generated report comprise instructions that cause the server computer to output the report to a post-processing environment selected from the group consisting of a spreadsheet application, a database application, a test script development environment, a warranty claim processing environment, a warranty analysis processing environment and an insurance claim processing environment.

60] The storage device according to claim 52, wherein the stored instructions that upon execution by the server computer cause the server computer to perform the step of outputting the generated report comprise instructions that cause the server computer to output the report to an end user display device.

61] The storage device according to claim 52, wherein the stored instructions that upon execution by the server computer cause the server computer to perform the step of generating the report comprise instructions that cause the server computer to generate the report based upon at least one criterion selected from the group consisting of item type, malfunction type, diagnostic device type, item manufacturer and specific test performed.

62] The storage device according to claim 52, wherein the one or more client diagnostic devices comprises a plurality of diagnostic devices.

63] A method for diagnostic data aggregation and reporting supporting analysis of diagnostic data from one or more diagnostic devices, the method comprising the steps of:
a) receiving a diagnostic data set from a first diagnostic device, wherein the diagnostic data set represents results from the first diagnostic device running one or more tests on a test item having a test item type;
b) storing the received diagnostic data set in a data store;
c) generating a report analyzing a subset of data from the data store;
d) outputting the generated report;
e) receiving a received script, wherein the received script contains instructions for use in running tests on test items having a test item type by a set of diagnostic devices specific to the diagnostic device manufacturer;
f) generating a new script from a subset of diagnostic data in the data store relevant to a selected set of diagnostic devices, wherein the received script contains instructions for use by the selected set of diagnostic devices in running tests on test items having a test item type;
g) storing scripts, received and generated, in the data store; and
h) transmitting a selected script from the data store to a second diagnostic device for which the selected script would be relevant.

64] A computer-readable storage device storing instructions that upon execution by a computer cause the computer to manage a diagnostic device by performing the steps comprising of:
a) monitoring a data store associated with the diagnostic device for the appearance of a diagnostic data set, wherein the diagnostic data set results from the diagnostic device running one or more tests on a test item having a test item type; and
b) upon detecting the appearance of the diagnostic data set in the data store, transmitting the diagnostic data set to an aggregation server.

65] The storage device according to claim 64, and storing further instruction that upon execution by the computer cause the computer to perform the step comprising of:
c) receiving at least one script from the aggregation server, wherein the received script contains instruction for use by the diagnostic devices in running tests on test items having a test item type and storing the received script in the data store.

66] The storage device according to claim 65, and storing further instruction that upon execution by the computer cause the computer to perform the steps comprising of:
d) receiving a test item type associated with a test item connected to the diagnostic device; and
e) generating a standardized interface for testing the connected test item based upon the received item type and a script in the data store associated with the received item type.

67] The storage device according to claim 66, wherein the stored instructions that upon execution by the computer cause the computer to perform the step of generating the standardized interface comprises instructions that cause the computer to generate the standardized interface independent without regard to a diagnostic device type.

68] The storage device according to claim 64, and storing further instruction that upon execution by the computer cause the computer to perform the steps comprising of:
c) receiving a test item type associated with a test item connected to the diagnostic device; and
d) generating a standardized interface for testing the connected test item based upon the received item type.
